(19) United States
(12) Patent Application Publication
(10) Pub. No.: US 2014/0229275 A1
(43) Pub. Date: Aug. 14, 2014

(54) CONTEXTUAL AD DISPLAY BASED ON REAL-TIME USER INPUT

(71) Applicant: CLICKTRIPZ, LLC, Manhattan Beach, CA (US)

(72) Inventors: Eric BJORNDAHL, Santa Cruz, CA (US); David BJORNDAHL, Austin, TX (US); Ross WEBER, Manhattan Beach, CA (US)

(73) Assignee: CLICKTRIPZ, LLC, Manhattan Beach, CA (US)

(21) Appl. No.: 13/767,772

(22) Filed: Feb. 14, 2013

(51) Int. Cl. G06Q 30/02

(52) U.S. Cl. CPC G06Q 30/0251
USPC 705/14.49

(57) ABSTRACT

A system and methods for facilitating contextual advertisement display based on real-time user input into a webpage of a publisher's properties (e.g., a website) are described. Various embodiments of the present invention advantageously allow contextual advertisements to be dynamically updated via an ad-affiliated server, without any complex involvement of the publisher or the advertisers. In one embodiment, a system for providing contextual advertisements based on user input and in accordance with advertising campaigns of a network of advertisers is disclosed. The system comprises an ad-affiliated server, a publisher, a network of advertisers, and a client browser. In one embodiment, a method for providing contextual advertisements via an embedded script code file is disclosed. In one embodiment, a method for providing contextual advertisements via an inline frame is disclosed. In some embodiments, advertising results associated with the contextual advertisements are generated upon a search form submission on the client browser.

### FIELD OF INVENTION

Various embodiments of the present invention generally relate to an advertisement system and methods. More particularly, various embodiments of the present invention relate to system and methods for contextual advertisement display based on real-time user input.

### BACKGROUND

The recent development of online advertisements has been focused on targeted advertising, where advertisements are selectively displayed to content consumers based on certain contexts. Targeted advertising offers a unique opportunity for publishers to monetize on content consumers and for advertisers to have effective advertising campaigns. However, it is often difficult to accurately identify and maintain the certain contexts for effective display of advertisements without a complex advertising system.

### SUMMARY

A system and methods for facilitating a display of contextual advertisements based on real-time user form input into a webpage of a publisher's properties (e.g., a website) are described. In one embodiment, a system for providing contextual advertisements based on real-time user input is disclosed. The system comprises an ad-affiliated server, a publisher, a network of advertisers, and a client browser. The ad-affiliated server is in communication with the network of advertisers. The publisher and the ad-affiliated server are in communication with the client browser. The publisher is configured to respond to requests from the client browser for a webpage and to deliver the webpage and its associated content to the client browser. The ad-affiliated server is configured to determine and deliver contextual advertisements to the client browser for display on the webpage, where the contextual advertisements are dynamically updated based on the user input on the webpage.

In yet another embodiment, a method for providing contextual advertisements via a script code file embedded in a website is disclosed. The publisher receives a script code file from the ad-affiliated server. The publisher embeds the script code file into an electronic form. The electronic form is generated on a webpage of the publisher's website being rendered in the client browser. The embedded script code file monitors a plurality of fields associated with the electronic form for any change in user input. Upon a detected change, the embedded script code file sends a request accompanied by real-time information to the ad-affiliated server. In return, the ad-affiliated server determines and delivers contextual advertisements to the client browser for display on the webpage, where the contextual advertisements are based on the real-time user-input data and in accordance with advertising campaigns of the network of advertisers. In embodiments, the embedded script code file contains display parameters configurable by the publisher. In embodiments, the embedded script code file enables any publisher to display contextual advertisements from the network of advertisers. The display of contextual advertisements is dynamically updated via facilitation of the ad-affiliated server, without any complex involvement of the publisher or the network of advertisers.

In yet another embodiment, a method for providing contextual advertisements via an inline frame in a webpage of a website is disclosed. An inline frame URL, provided by an ad-affiliated server, is received by the publisher. The publisher generates a webpage on its website containing the inline frame. The inline frame is in communication with the ad-affiliated server and is capable of receiving advertising content from the ad-affiliated server. The inline frame operates as a standalone advertising unit accompanying the webpage of the publisher's website. The ad-affiliated server delivers advertising content to the inline frame, where the advertising content includes an electronic form and contextual advertisements associated with the electronic form. The contextual advertisements are dynamically updated by the ad-affiliated server based on user input in the electronic form and in accordance with advertising campaigns of the network of advertisers. In embodiments, the inline frame's advertising content is dynamically updated via facilitation of the ad-affiliated server, without any complex involvement of the publisher or the network of advertisers. The use of the inline frame enables automated targeted advertising to occur separate from the main content of the webpage.

While multiple embodiments are disclosed, still other embodiments of the present invention will become apparent to those skilled in the art from the following Detailed Description, which shows and describes illustrative embodiments of the present invention. As will be realized, the present invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

One or more embodiments of the present invention are illustrated by way of example and not limitation in the figures of the accompanying drawings.

FIG. 1 is a block diagram of a networked-based environment in which a method for contextual advertisement display using an embedded script code can be implemented according to an embodiment of the present invention.

FIG. 2 is a flow diagram illustrating an example process for implementing a contextual advertisement display via embedded script code according to an embodiment of the present invention.

FIG. 3 is an example of a user interface to a publisher's travel search service containing the publisher's search form embedded with a script code according to an embodiment of the present invention.

FIG. 4 is a sequence diagram illustrating an embodiment of the interaction sequences between the ad-affiliated server, the publisher, and the client browser.

FIG. 5 is a block diagram of a network-based environment in which a method for contextual advertisement display using an inline frame can be implemented according to an embodiment of the present invention.

FIG. 6 is an example of a user interface to a publisher's website containing an inline frame according to an embodiment of the present invention.

### DETAILED DESCRIPTION

A system and methods for contextual advertisement display based on real-time user input are described. In some embodiments, the system and methods are used to provide contextual advertisements for display on a publisher's properties (e.g., website, mobile browser application, etc.), where providing the contextual advertisements for display is occurring over a network including one or more local area networks (LANs), a wide area network (WAN) (e.g., the Internet), or wireless networks. Any reference herein to “contextual advertisements” is meant to include any such method occurring over a network, and is not limited to the Internet. Further, by way of example, the system and methods are discussed in an online website context, but other contexts are possible.

Conducting a successful advertising campaign with any publisher involves deciding where, when, or under what circumstances an advertisement should be displayed. Particularly, for a search engine related website, effective display of advertisements can be better facilitated by monitoring real-time user input associated with search queries. Targeting sets accompanying the monitoring of the search queries can be used to define the advertisement display. A car rental company's location-centric advertising campaign, for example, can set targeting parameters to target certain form fields of a publisher's car rental search form (e.g., a pick-up location or drop-off location field), where these certain form fields trigger contextual advertisements to be provided to content consumers. In this example, company X chooses to have its campaign focus on the SFO pick-up location, and so sets to have its advertisements be triggered for display only when the user enters the value “SFO” in the targeted form field (i.e., pick-up location). In another example, for a date-based advertising campaign, the targeting set can include a departure date field and a return date field, where the set triggers a display of contextual advertisements based on the dates entered on a webpage of a flight-related publisher's website (e.g., display advertisements only for advertisers targeting July 4th week).

In one embodiment, a system for providing contextual advertisements tailored to targeting sets associated with advertising campaigns of a network of advertisers is disclosed. The system comprises an ad-affiliated server, a publisher, a network of advertisers, and a client browser. The ad-affiliated server is in communication with the network of advertisers and receives advertising campaign information from the advertisers. Additionally, the ad-affiliated server and the publisher are in communication with the client browser. The publisher is configured to respond to requests from the client browser for a webpage and to deliver the web page and its associated content to the client browser. The ad-affiliated server is configured to deliver contextual advertisements to the client browser for display on the webpage, where the contextual advertisements are dynamically updated based on the user input on the webpage and in accordance with advertising campaigns of the network of advertisers.

Various methods associated with the system allow contextual advertisements to be displayed dynamically on the publisher's website without any complex involvement of the publisher or the network of advertisers. In one embodiment, a method for providing the contextual advertisements for display via an embedded script code is disclosed. In yet another embodiment, a method for providing the contextual advertisements for display via an inline frame is disclosed.

The various embodiments of the present invention disclosed can provide one or more of the following advantages: (1) allowing easy integration of real-time contextual advertisements into a publisher's existing properties (e.g., website); (2) allowing dynamic, automatic update of the contextual advertisements in accordance with one or more advertising campaigns belonging to a network of advertisers; and (3) allowing the network of advertisers to have the targeting functionality without any need to store the functionality on their own servers.

While, for convenience, embodiments of the present invention are described with reference to travel-related publishers, embodiments of the present invention are equally applicable to various other applications where a comparison among a network of competitors is utilized. For example, embodiments of the real-time contextual advertisement methods disclosed can be applied to an insurance publisher, where a comparison of insurance quotes among a network of insurance carriers seek to advertise their respective insurance services on the insurance publisher's properties. Other examples include retail (or shopping) companies, mortgage services, car dealers, etc. —virtually anywhere where (1) the comparison of a network of competitors and (2) the displaying of dynamic results based on user-input play a role.

Various aspects and examples of the invention will now be described with reference made to the accompanying drawings. Wherever practicable, the same reference numbers will be used throughout the drawings to refer to the same or like parts. Note that the following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

### TERMINOLOGY

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

The phrases “in some embodiments,” “according to various embodiments,” in the embodiments shown,” “in other embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or to different embodiments.

The words “herein,” “above,” “below,” and words of similar import, when used in this application, refer to this application as a whole and not to any particular portions of this application. The words “comprise,” “comprising,” and the like are to be construed in an inclusive sense (i.e., to say, in the sense of “including, but not limited to”), as opposed to an exclusive or exhaustive sense. Additionally, the terms “connected,” “coupled,” or any variant thereof means any connection or coupling, either direct or indirect, between two or more elements. Such a coupling or connection between the elements can be physical, logical, or a combination thereof.

Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. Further, if the Detailed Description states a component or feature “may,” “can,” “could,” or “might” have a characteristic or be included, that particular component or feature is not required to have that characteristic or be included.

### General Description

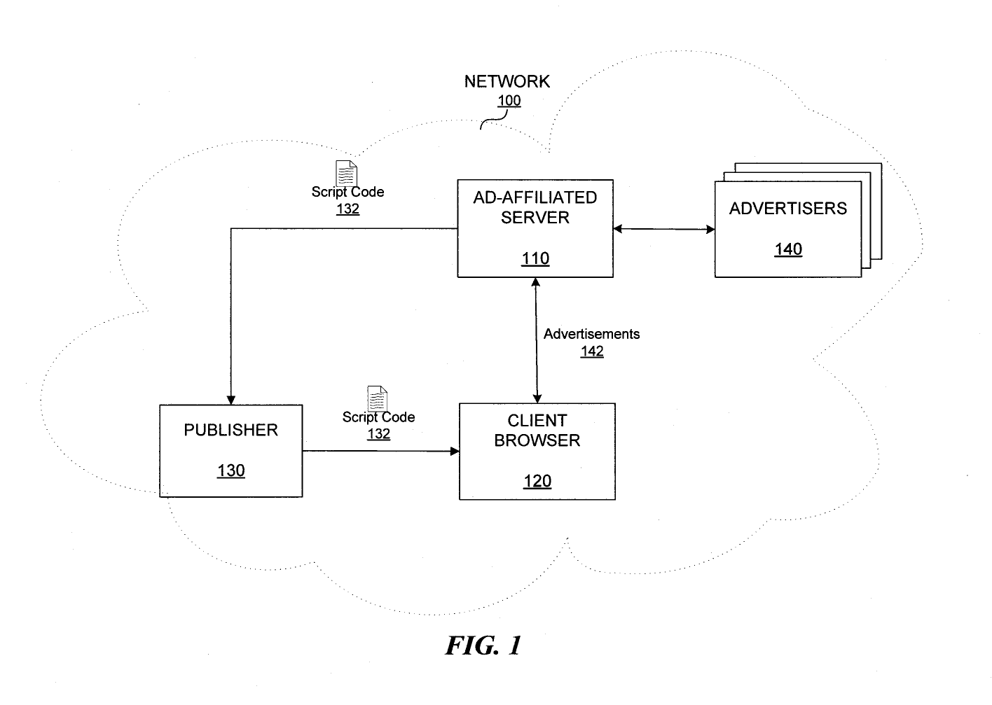

FIG. 1 illustrates an example of a network-based environment 100 in which an embodiment of the present invention can be implemented. In some embodiments, central to the network-based environment 100 is an ad-affiliated server 110, which is in communication with a network of advertisers 140 and a publisher 130. In other embodiments, the ad-affiliated server 110 is connected to more than one publisher 130 (e.g., a network of publishers).

In embodiments, the network of advertisers 140 can submit, maintain, and track advertisements and associated information via the ad-affiliated server 110. The advertisements can be in the form of graphical ads (e.g., banner ads), text-only ads, image ads, audio ads, video ads, or ads combining one or more of any of such components. The associated information can be advertising campaign information. The network of advertisers 140 can maintain one or more advertising campaigns, for example, with the publisher 130 via the ad-affiliated server 110 such that contextual advertisements 142 can be served to the publisher 130 according to the one or more advertising campaigns.

The network of advertisers 140 can submit information associated with their respective advertising campaigns to the ad-affiliated server 110 periodically, automatically or manually. The advertising campaign information can be, for example, in a specific file format or a plain-text file sent via email. With the advertising campaign information, the ad-affiliated server 140 is able to make various decisions, such as, for example, how to define the contextual advertisements (e.g., which set of advertisers) to be displayed on a website of the publisher 130. The network of advertisers 140 can specify certain targeting sets related to their respective advertising campaigns, where the targeting sets indicate the certain contexts in which the advertisers want their advertisements to be displayed. An advertiser's advertising targeting set for car rental related websites includes, for example, a pick-up form field and a drop-off form field targeting specific data input (e.g., displaying advertisements only for “LAX” pick-up location). A targeting set for flights-related websites includes, for example, departure date field, return date field, origin field, and destination field. A targeting set for hotel related websites targets, for example, check-in date form field associated with citywide hotel searches. In yet another example, a targeting set can be specified for package deals, such as a one-way or a round-trip vacation package targeting.

The network of advertisers 140 can also specify particular types of publishers being targeted in their respective advertising campaigns. Using the publisher-specified preferences, the ad-affiliated server 110 serves the contextual advertisements 142 to particular types of publishers using only certain advertisers from the network of advertisers 140. For example, the ad-affiliated server 110 serves advertisements of car rental advertisers only to a publisher with a publisher ID indicating that it is a car rental search website, and hotel advertisers are not displayed on that publisher's website.

In embodiments, the network of advertisers 140 is able to have their advertisements displayed with the publisher 130 via the ad-affiliated server 110. One example of the publisher 130 is a general content server that receives requests for content (e.g., dynamic web page content, search results, information feeds, web page listings, graphics, music, video, etc.) from a content consumer, or user, using a client browser 120, and retrieves the requested content in response to the request.

In another example, the publisher 130 is a search service. A search service can receive search queries from the user for search results. The user using the search service may enter data into an electronic form, such as a search form, on a webpage of a website provided by the search service. While the user is inputting data into the electronic form, contextual advertisements 142 can be displayed and dynamically updated based on user input. The contextual advertisements 142 can be a part of the electronic form to provide an additional search option for the user. The contextual advertisements can be displayed within a designated advertising area or space configured by the publisher 130. The contextual advertisements 142 is contained, for example, within a “Compare” strip attached to the electronic form. This “Compare” strip of content can include one or more advertisers dynamically and contextually generated via the ad-affiliated server 110. The “Compare” strip allows the user, for example, to compare content from the publisher's website with the content from the one or more advertisers. In some instances, the “Compare” strip can be displayed upon an initial load of the website, where the “Compare” strip contains a set of default advertisers. In other instances, the “Compare” strip is not displayed at all upon the initial load (e.g., null set of advertisers), and is displayed only once the user input is entered into the electronic form.

In the example, in response to the user's submission of the search queries in the electronic form, the search service (i.e., publisher 130) can retrieve relevant search results from an index of content (e.g., from an index of web pages) and serve those search results to the user. Search results can include, for example, lists of web page titles, snippets of text extracted from those web pages, and hypertext links to those web pages. In some embodiments, additional search results are generated by the ad-affiliated server 110, where the additional search results are advertising results associated with a subset of advertisers extracted from the network of advertisers 140. The combined results, from the ad-affiliated server 110 and the publisher 130, can be displayed to the user in a variety of methods. In some embodiments, the search results are maintained as distinct, separate results from the advertising results, so that the user is not confused which are paid advertisements and which are presumably neutral search results. The advertising results, for example, are displayed in a browser window separate from the main window of the website, such as a pop-up window or a pop-under window.

In embodiments, the ad-affiliated server 110 helps facilitate the advertising campaigns between the network of advertisers 140 and the publisher 130 by serving targeted contextual advertisements 142 to the client browser 120. The ad-affiliated server 110 is in connection with the network of advertisers 140 and the publisher 130, such that the ad-affiliated server 110 can easily edit the embedded script code file, ensuring appropriate contextual advertisements 142 are served to the client browser 120 via the publisher's website.

In embodiments, any client browser 120 operating on a client device may receive the targeted contextual advertisements 142. The client browser 120 can be configured to communicate via the network 100, which may comprise any combination of local area and/or wide area networks, using both wired and wireless communication systems. The client browser 120 can be executed on any computing device capable of receiving user input as well as transmitting and/or receiving data via the network 100. In one embodiment, the client browser 120 is a browsing application executed on a conventional computer system, such as a laptop computer. For example, a user can run a Mozilla Firefox browser to access the publisher's website content, enabling interaction between the publisher 130 and the ad-affiliated server 110, such that the contextual advertisements 142 can be updated based on the user's input. In another embodiment, the client browser 120 may be a mobile browser application executed on a mobile device having computer functionality, such as a personal digital assistant (PDA), mobile telephone, smart-phone or similar device. The client browser 120 is configured to communicate with the ad-affiliated server 110 via the network 100 to access the publisher's distributed content on the publisher's website.

The network 100 connects the network of advertisers 140, the publisher 130, the client browser 120, and the ad-affiliated server 110. The network 100 uses standard communications technologies and/or protocols. Thus, the network 100 may include links using technologies such as Ethernet, 802.11, worldwide interoperability for microwave access (WiMAX), 3G, 4G, CDMA, digital subscriber line (DSL), etc. Similarly, the networking protocols used on network 100 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over network 100 may be represented using technologies and/or formats including hypertext markup language (HTML) or extensible markup language (XML). In addition, all or some of links can be encrypted using conventional encryption technologies such as secure sockets layer (SSL), transport layer security (TLS), and Internet Protocol security (IPsec).

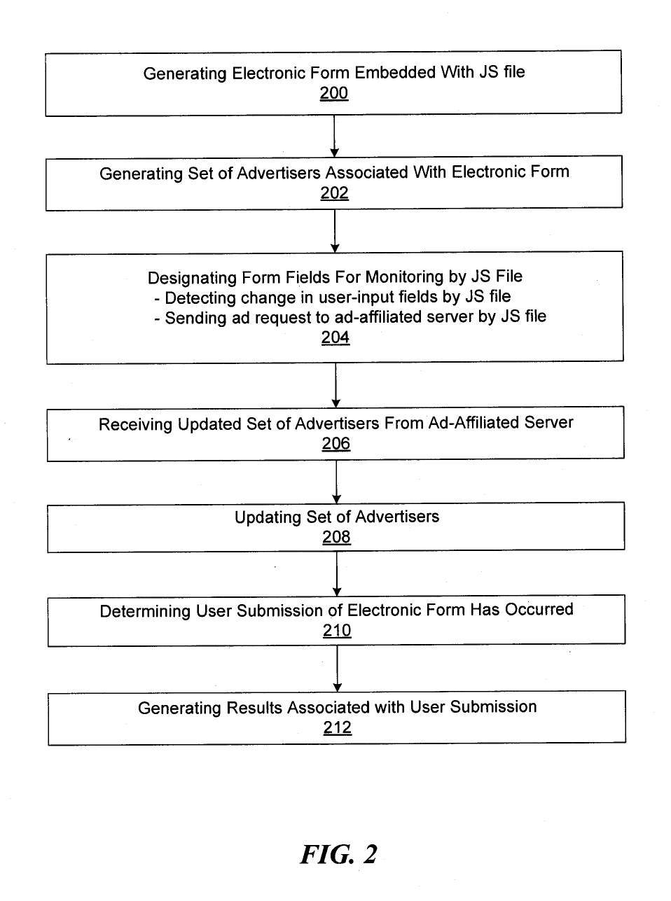

FIG. 2 is a flow diagram illustrating an example process for implementing a contextual advertisement display according to an embodiment of the present invention. In embodiments, the ad-affiliated server 110 facilitates the advertising campaigns of the network of advertisers by providing a script code file 132, such as a JavaScript file, to the publisher 130. The publisher 130 embeds the script code file 132 into an electronic form generated on a webpage of the publisher's website. A user (i.e., client) on a client device runs the client browser 120 to access the electronic form. The term “electronic form” as used herein can be any form capable of receiving user input for processing by a system. In some embodiments, the electronic form is a search form capable of receiving search queries submitted by a user. In one example, the search form is incorporated with a general content search engine, such as the GOOGLE® search engine. In another example, the search form is incorporated with a travel-related search service where the search form includes a plurality of user-input form fields capable of receiving search criteria, such as Hotwire.com®. The embedded script code file 132 causes the ad-affiliated server 110 to deliver the contextual advertisements 142 dynamically in response to the user's real-time data input in the electronic form. Further, the contextual advertisements returned from the ad-affiliated server 110 are in accordance to advertising campaigns of the network of advertisers 140.

An embodiment of the method is described in detail in FIG. 2. In step 200, the publisher 130 generates an electronic form on the publisher's website that is accessed by the client browser 120. As discussed above, the electronic form is embedded with the script code file 132 provided by the ad-affiliated server 110. The method according to the embodiment in FIG. 2 is implemented using a JavaScript file. Note, however, the method is not limited to JavaScript and is applicable to any scripting language implementation. In embodiments, the JavaScript file (or simply, “JS file”) enables interaction between the ad-affiliated server 110 and the client browser 120, such that contextual advertisements may be served dynamically to the publisher's website based on the real-time data input in the electronic form.

In step 202, the publisher 130 generates a set of advertisers along with the electronic form on the publisher's website. As discussed above, according to one embodiment, the set of advertisers is contained in a “Compare” strip attached to the electronic form. The “Compare” strip, containing the set of advertisers, is generated as a result of the embedded JS file. The “Compare” strip, displayed with the electronic form, contains a dynamically changing set of advertisers that are contextually updated based on user input data in the electronic form. In embodiments, an initial display of the “Compare” strip can be configured according to parameters set by the publisher 130. The display configurations are located within the JS file accessible by the publisher 130. The display configurations can include, for example, a minimum or maximum number of advertisers to display.

In some embodiments, the publisher 130 configures the initial display of the “Compare” strip to contain a null set of advertisers (i.e., no advertisers). The publisher 130, for example, sets parameters of the display configurations in the JS file to have no advertisements displayed upon initial load of the publisher's website on the client browser 120. In this example, the publisher 130 chooses to have the initial load displaying only the electronic form, with no “Compare” strip attached. In other embodiments, the initial display of the “Compare” strip is set to contain a default set of advertisers upon the initial upload. For example, the default set includes any available advertisers (e.g., advertisers with no particular advertising campaign and with a desire to be displayed at all times). In some embodiments, the publisher 130 configures a default selection of the advertisers displayed. For example, the publisher 130 sets the display configurations to have at least one advertiser selected among the set of advertisers displayed in the “Compare” strip.

In step 204, along with generating the electronic form, the publisher 130 designates a plurality of user-input fields of the electronic form to be monitored by the JS file. Once the electronic form is generated on the website, the embedded JS file automatically monitors the designated user-input fields for any change in content. The change in the content is detected based on any real-time user-input data present in the designated user-input fields. An advertiser request (or simply, “ad request”) for updated advertisements, such as the contextual advertisements 142, is triggered upon detection of any change in the content in any of the designated user-input fields. For example, the ad request is an AJAX request corresponding to the JS file embedded in the publisher's website.

The ad request is sent to the ad-affiliated server 110 to obtain updated contextual advertisements 142 corresponding to the real-time user-input data detected. In embodiments, the contextual advertisements 142 presents the user an option to search content of the one or more advertisers displayed in the contextual advertisements 142, in addition to content of the publisher's website. For example, the contextual advertisements 142 is embodied in a “Compare” strip of content attached to the electronic form generated on the publisher's website. The “Compare” strip of content contains the subset of advertisers extracted from the network of advertisers 140. As will be discussed in further detail below, the subset of advertisers is determined based on the user input and in accordance with targeting parameters set by the advertising campaigns of the network of advertisers 140.

The ad request is accompanied by real-time information. The ad-affiliated server utilizes the real-time information for determining an appropriate set of advertisers to return to the website. The real-time information comprises form metadata and user-input data. The form metadata can include identity data of elements associated with the electronic form, such as a publisher ID datum, a form ID datum, a form field ID datum, etc. The user-input data can include user-selected data or user-created data found in the plurality of user-input fields (e.g., the city entered in the Destination form field).

In addition to the real-time information, the ad-affiliated server 110 takes into consideration targeting sets specified by the network of advertisers 140 when determining the appropriate set of advertisers. In some instances, the network of advertisers 140 may have no preference, and may want to be displayed at all times on any publisher's website. In other instances, the network of advertisers 140 may only want to target advertisements according to certain target elements (e.g., date targeting, destination targeting, room targeting, etc.). For example, for date targeting, an advertiser may want to only be displayed on a publisher's website if the check-out date being searched by the user is within the next x days. In another example, for room targeting, an advertiser may want to be displayed on a publisher's website only if the number of hotel rooms being searched by a user is 10+ rooms (i.e., group booking targeting). In yet another example, for publisher-type targeting, an advertiser may want to be displayed only on a hotel-related publisher's website. As discussed above, advertisers in the network of advertisers 140 can send their respective advertising campaign information to the ad-affiliated server 110 periodically. Using this periodically updated information, in addition to the real-time information, the ad-affiliated server 110 facilitates the contextual advertisements 142 to be served to the client's browser 120.

In step 206, the website receives a determined set of advertisers returned from the ad-affiliated server 110. The publisher 130 may want to control the display of the set of advertisers returned from the ad-affiliated server 110. For example, certain features of the “Compare” strip containing the subset of advertisers can be configured according to the publisher's customized parameters. These configurable features include but are not limited to: the maximum number of advertisers to display; the maximum number of advertisers associated with advertising results to be generated upon a user submission of the electronic form; whether to generate advertising results as pop-up displays or as pop-under displays; whether to display contextual advertisements as images or text; and custom event handler options.

In step 208, the existing contextual advertisements (i.e., existing set of advertisers) are dynamically updated according to the determined set of advertisers returned from the ad-affiliated server 110. For example, the “Compare” strip now contains three advertisers (instead of the previous four advertisers) when the user changes the location criterion in the electronic form. At step 210, the publisher 130 determines whether the user is finished entering search criteria, based on a detection of whether a user submission of the electronic form has occurred.

At this decision step, if the user submission has not occurred, the JS file continues monitoring the plurality of user-input fields. The JS file implements actions associated with the monitoring, and the publisher takes no action. During this monitoring period, steps 206-210 repeat until the user submission occurs. If the user submission has occurred, the publisher proceeds to step 212 and generates results in response to the user's search criteria submitted. In some embodiments, the user submission comprises the user's submission of search criteria in the user-input fields, in addition to, the user's selection of the advertisers in displayed in the “Compare” strip attached to the electronic form. As such, the results returned to the user in step 212 can include search results associated with the publisher's website and advertising results associated with a subset of advertisers selected from the contextual advertisements. In other embodiments, the results include only search results associated with the publisher's website, where the user has chosen not to select any advertiser displayed in the “Compare” strip.

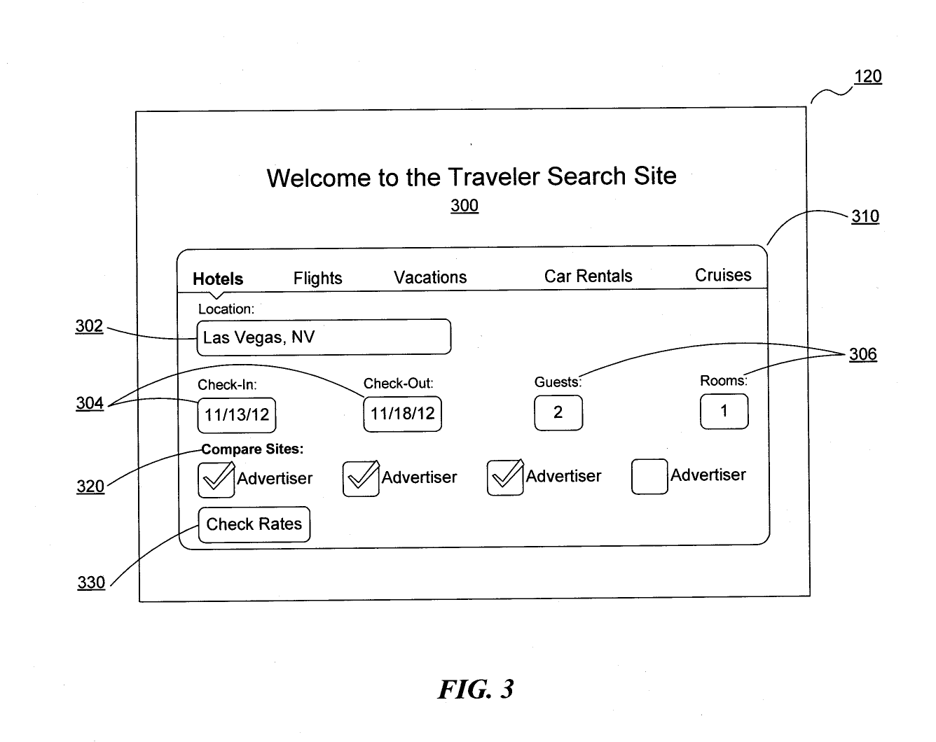

FIG. 3 is an example of a user interface to a publisher's travel search service containing a search form embedded with a script code according to an embodiment of the present invention. In FIG. 3, the publisher 130 is a travel search service providing a travel search engine 300 on its website accessible by the client browser 120. The search engine 300 offers a search form 310 for a user to enter search queries to request for search results related to the user's desired travel criteria. In the example shown, the user utilizes the search form 310 to search for hotels fitting certain search criteria. As shown in the example, the search form 310 includes a plurality of user-input fields (e.g., 302, 304, 306) and, attached to the search form, an area designated for advertising by the publisher 130. This designated area, or designated advertising space, contains a “Compare Sites” strip of content (i.e., a list of four advertisers). In the example, the “Compare Sites” strip operates as a display of the contextual advertisements.

As discussed above, the strip of content, or list of advertisers, is dynamically updated based on real-time user-input data in the plurality of user-input fields associated with the search form 310. The search form 310 is embedded with the script code file 132, which monitors the user's search query inputs (i.e., real-time user-input data) in the plurality of user-input fields. Upon a detection of any change in these fields, the script code file 132 causes an ad request to be sent to the ad-affiliated server 110. As discussed above, the ad-affiliated server 110 determines a contextually appropriate set of advertisers to send back for display on the website based on the user-input data, and based on the advertising campaigns of the network of advertisers 140.

The ad-affiliated server 110 may return only the advertisers with advertising campaigns that target certain form fields with particular form data input in the search form 310. For example, an advertiser may choose destination location targeting, where only form data in the user-input field 302 are relevant to that advertiser. When The Hard Rock Café Hotel®, for example, is the only advertiser that has an advertising campaign targeting the location Las Vegas, Nev. (i.e., users looking for hotels in Las Vegas, Nev.), the ad-affiliated server will only return “Hard Rock Café Hotel” when it receives “Las Vegas, Nev.” form data extracted from the user-input field 302. In another example, the advertiser may choose to target a particular travel search (e.g., hotel search), where the advertising campaign is focused on a broad targeting set that includes all form fields, not just a location form field, associated with the particular travel search. In this example, the advertiser is displayed every time a user chooses to search for hotels, and is not displayed if the user searches, for example, flights or car rentals. In the example illustrated in FIG. 3, both advertisers in the above examples with the two different advertising campaigns (i.e., broad search-type targeting and location-based targeting) will be displayed for the “Las Vegas, Nev. hotel” search.

In the example as shown in FIG. 3, the user, via the client browser 120, may submit the search form 310 using the “Check Rates” button 330. In embodiments, this user submission, via the “Check Rates” button 330, comprises a final input of data in the plurality of user-input fields (i.e., location, check-in date, check-out date, number of guests, and number of rooms) and a final selection of advertisers from the four available advertisers (i.e., a selection of the contextual advertisements 320). Results are returned to the user subsequent to the user submission. In some instances, the final selection of advertisers is null, that is, the user chooses not to select any advertiser from the “Compare Sites” strip. As such, the results include only search results associated with the search engine 300. In other instances, the final selection of advertisers includes a selection of some advertisers. As such, the results include the search results associated with the search engine 300 and advertising results associated with the selected advertisers (e.g., one selected advertiser). The advertising results, for example, displays The Hard Rock Café Hotel® in Las Vegas and a list of available room options at that hotel, and the room options correspond to the input data submitted in the plurality of user-input fields.

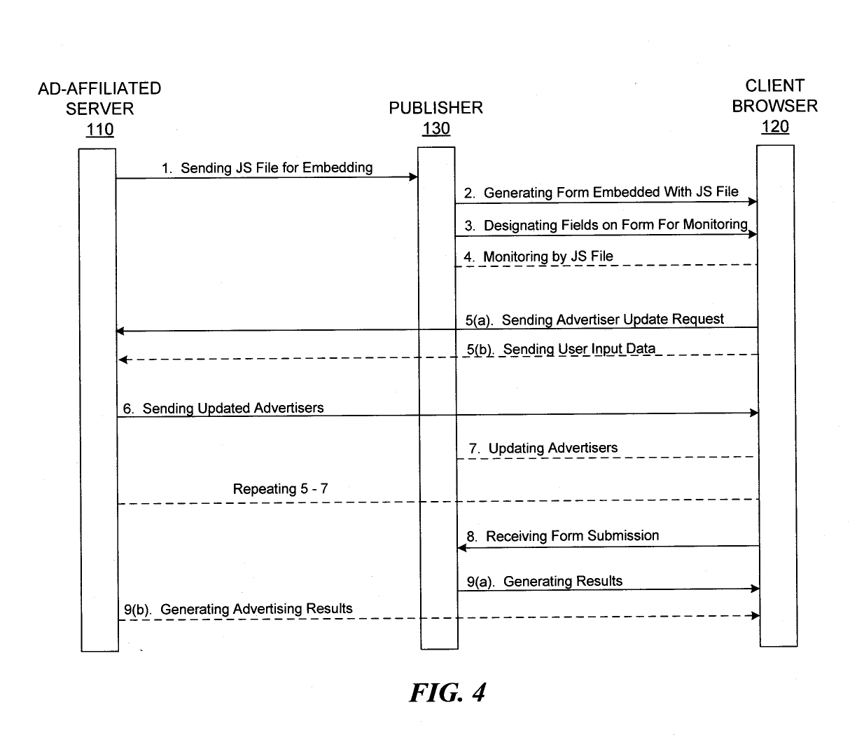

FIG. 4 is a sequence diagram illustrating the interaction sequences between the ad-affiliated server 110, the publisher 130, and the client browser 120 according to an embodiment of the present invention. In step 1, the ad-affiliated server 110 sends a script code file, such as a JavaScript file (“JS file”), to the publisher 130. In step 2, the publisher 130 generates a search form on the publisher's website, which is published and accessed via the client browser 120. The publisher 130 embeds the JS file, received from the ad-affiliated server, into the search form when publishing the form. Additionally, the publisher 130 configures parameters in the embedded JS file to communicate and designate the form fields existing in the search form to be monitored, enabling the JS file to start monitoring, as indicated by step 3.

In step 4, monitoring of the designated form fields takes place, where the monitoring is being automatically performed by the embedded JS file. The JS file monitors each of the form fields for any change in user-input, including user-created data (e.g., free-form data entered into a form field) and user-selected data (e.g., selection of preset data in a form field). In step 5(a), upon detection of a change in any of the form fields, the website operating on the client browser is triggered by the JS file to send a request (e.g., an AJAX request) to the ad-affiliated server 110. The request is an advertiser update request inquiring for contextual advertisements that correspond to the detected change in the form fields detected by the JS file. As indicated by step 5(b), the advertiser update request is accompanied by real-time information, which includes the user-input data detected in the form fields.

In step 6, the ad-affiliated server 110 determines an appropriate set of advertisers based on the user-input data detected in the form fields and sends that set of advertisers back to the website operating on the client browser 120. The ad-affiliated server 110 filters the set of advertisers to return based on the user-input data and in accordance to targeting sets associated with advertising campaigns received from the network of advertisers 140. As discussed above, in this determination, the ad-affiliated server 110 may return only those advertisers with advertising campaigns targeting the particular form data received in the advertiser update request. For example, where only the advertiser Virgin America has an advertising campaign that maintains destination and origin location targeting specifically for LAX and SFO, the ad-affiliated server will only return “Virgin America” to the website for the form data of LAX and SFO. In another example, all advertisers with broad advertising campaigns (e.g., advertisers with broad targeting sets and/or advertisers with no targeting sets at all) are returned by the ad-affiliated server 110. In step 7, after receiving the new set of advertisers, the website operating on the client browser 120 updates its display of advertisers (i.e., the contextual advertisements). Steps 5-7 are repeated until the user submits the search form.

In step 8, the publisher 130 receives a user submission of the search form. In step 9(a), the publisher 130 generates search results corresponding to search queries in the user submission. In some instances, the user submission includes a selection of a subset of the set of advertisers displayed on the website. In such instances, the results associated with the selected subset of advertisers are also generated subsequent to the user submission, as indicated in step 9(b). In step 9(b), advertising results are generated via the ad-affiliated server 110 upon a user submission that includes a selection of advertisers. As discussed above, the selected advertisers' results can be generated on a display separate from the publisher's results (e.g., pop-up window). In some instances, the user may choose to select none of the advertisers displayed. In these instances, no results associated with the advertisers will be displayed, and only step 9(a) takes place.

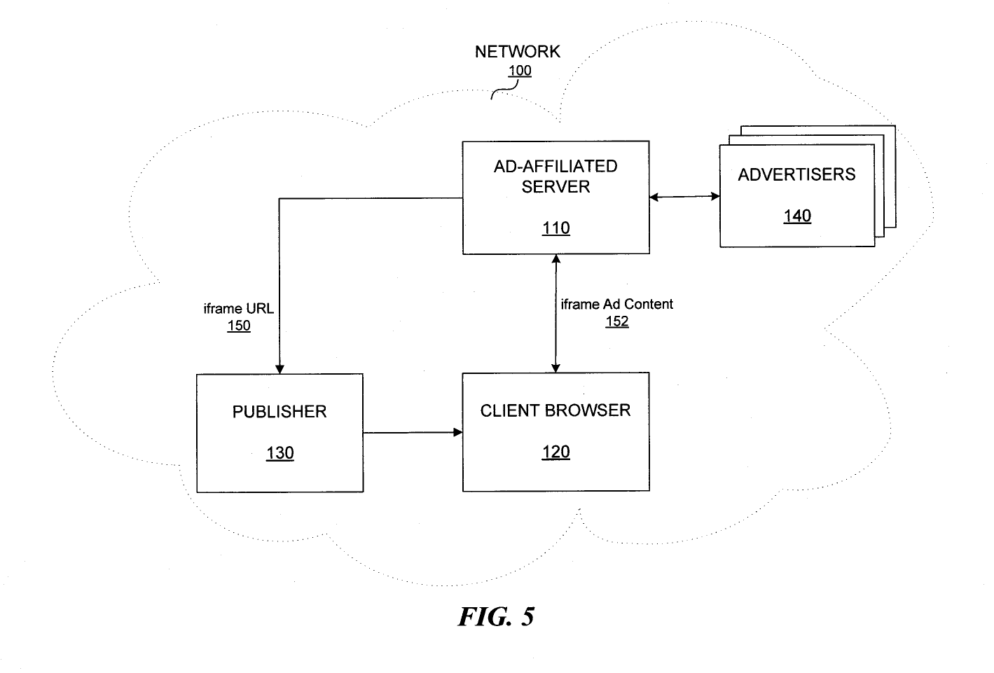

FIG. 5 is a block diagram of a network-based environment 100 in which an inline frame technique for contextual advertisement display can be implemented according to an embodiment of the present invention. In embodiments, the contextual advertisements 142 can be delivered from the ad-affiliated server 110 via an inline frame (or simply, “iframe”) embedded within one or more webpages of the publisher's website executed on the client browser 120. The term “iframe” as used herein is a standard inline frame known by those of ordinary skill in the art, where the inline frame is a DOM element typically used to embed an HTML document within another HTML document on a website.

In embodiments, the ad-affiliated server 110 facilitates contextual advertisements 142 of the network of advertisers 140 by delivering iframe ad content 152 to an iframe incorporated with the publisher's website, which is published and accessed via the client browser 120. The iframe is incorporated using an iframe URL 150 received by the publisher 130 from the ad-affiliated server 110. The iframe ad content 152 includes content that is separate from content of the publisher's website, such as advertising content.

In embodiments, the iframe ad content 152 includes the contextual advertisements 142. As discussed above, the contextual advertisements 142 are dynamically updated based on the user's data input and in accordance to advertising campaigns of advertisers belonging to the network of advertisers 140. In one example, the iframe ad content 152, is contained within a standalone advertising unit for travel search websites. The advertising unit is an HTML document that is embedded, for example, inside an iframe within a traveler's blog website. The iframe ad content 152 includes a search form that allows a user of the blog website, for example, to search for travel deals provided by a set of advertising travel search websites within the advertising unit. In the example, the set of advertising websites is dynamically and contextually updated based on the user's data input and in accordance to the advertising campaigns of advertising travel search websites.

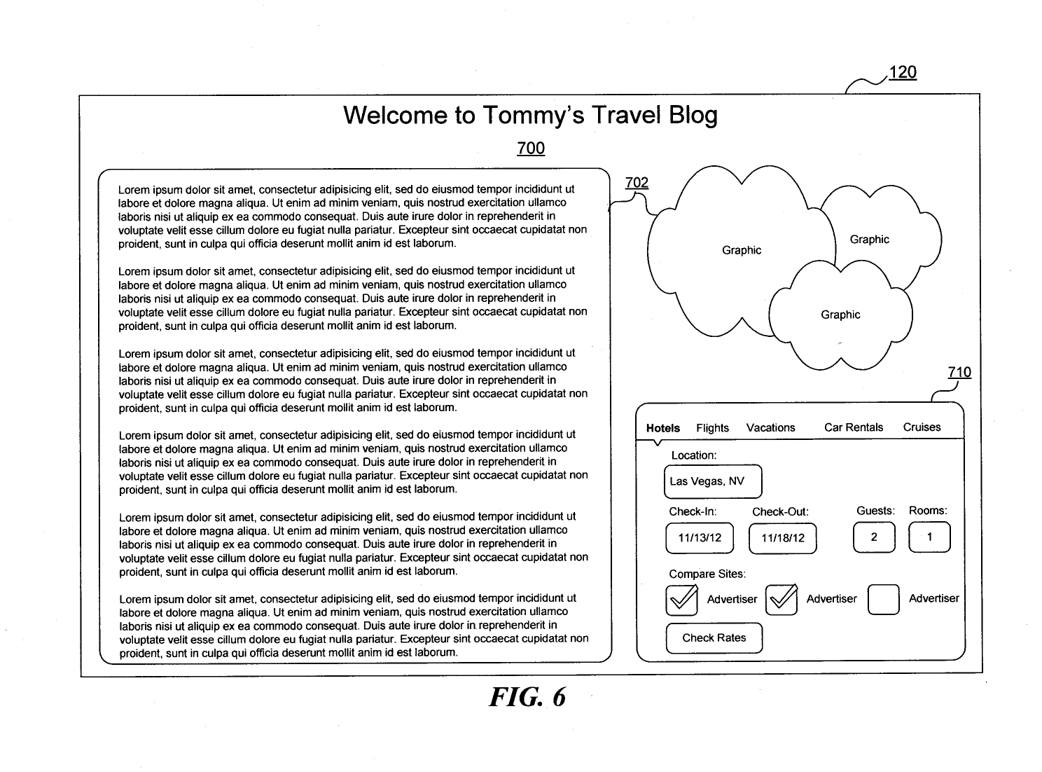

FIG. 6 is an example of a user interface to a travel search service website containing an inline frame according to an embodiment of the present invention. As shown in FIG. 6, a user accesses content on a webpage of Tommy's Travel Blog website 700 via the client browser 120. A standalone advertising unit 710, set within an iframe, is embedded in a webpage of the website 700. In the example as shown, the publisher 130 designates an advertising area for the standalone advertising unit 710 to be displayed along with content 702 of the webpage. The advertising unit 710 is populated with the iframe ad content 152. The iframe ad content 152 is provided by the ad-affiliated server 110. The iframe ad content 152 comprises an electronic search form and a “Compare Sites” strip. The “Compare Sites” strip operates as the contextual advertisements 142 and contains a set of advertisers dynamically and contextually served to the advertising unit 710 by the ad-affiliated server 110. The set of advertisers is updated based on the user's input data in the electronic search form and based on various advertising campaigns of the network of advertisers 140 connected to the ad-affiliated server 110.

In embodiments, upon a user submission of the electronic search form inside the advertising unit 710, search results associated with the set of advertisers are generated. In embodiments, at least one advertiser must be selected for search results to be generated, as the electronic search form is tied to the content provided by the advertisers displayed in the advertising unit 710.

### CONCLUSION

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A method comprising:
receiving a script code from an ad-affiliated server;
generating an electronic form embedded with the script code, the electronic form including a set of advertisers generated upon execution of the embedded script code, the embedded script code being configured to monitor a plurality of user-input fields associated with the electronic form, wherein the monitoring includes detecting a change of user-input in at least one of the plurality of user-input fields and sending an advertiser update request to the ad-affiliated server in response to a detected change;
receiving an updated set of advertisers returned from the ad-affiliated server, the updated set of advertisers being based on the user-input and in accordance with targeting parameters set by a network of advertisers connected to the ad-affiliated server; and
updating the set of advertisers.

2. The method of claim 1, wherein the set of advertisers generated upon execution of the embedded script code comprises a null set of advertisers.

3. The method of claim 1, wherein the advertiser update request comprises real-time information associated with the electronic form, the real-time information containing the user-input and form metadata, wherein the real-time information is utilized by the ad-affiliated server to determine, from the network of advertisers, a subset of advertisers that corresponds to the targeting parameters.

4. The method of claim 3, wherein the user-input comprises at least one of user-selected data or user-created data and wherein the form metadata comprises at least one of a publisher ID, a form ID, and a form field ID.

5. The method of claim 1 further comprising generating a plurality of results in response to a user-submission of the electronic form.

6. The method of claim 5, wherein the plurality of results comprises a plurality of advertising results associated with a plurality of advertisers selected in the user-submission, the plurality of advertising results containing search results associated with the plurality of advertisers and based on the user input in the plurality of user-input fields submitted in the user-submission.

7. The method of claim 6, wherein the plurality of advertising results is generated using at least one of: a pop-up display; and a pop-under display.

8. The method of claim 1, wherein the embedded script code comprises a set of display configurations, the set of display configurations contains at least one of:
a maximum number of advertisers to be generated;
a maximum number of advertising results to be generated subsequent to a user-submission of the electronic form;
a custom event handler;
an image or text display option; and
a pop-up or pop-under display option.

9. A method comprising:
receiving a script code from an ad-affiliated server;
generating on a client browser an electronic form embedded with the script code, the electronic form including a set of advertisers generated upon execution of the embedded script code, the embedded script code being configured to monitor a plurality of user-input fields associated with the electronic form, wherein the monitoring includes detecting a change of user-input in at least one of the plurality of user-input fields and sending an ad request to the ad-affiliated server in response to a detected change;
updating the set of advertisers associated with the electronic form with contextual advertisements returned from the ad-affiliated server; and
generating a plurality of results in response to a user-submission of the electronic form, the plurality of results including advertising results associated with the contextual advertisements.

10. The method of claim 9, wherein the set of advertisers generated upon execution of the embedded script code comprises a null set of advertisers.

11. The method of claim 9, wherein the ad request comprises real-time information associated with the electronic form, the real-time information including form metadata and the user-input, wherein the real-time information is utilized by the ad-affiliated server to determine the contextual advertisements that correspond to targeting parameters set by a network of advertisers connected to the ad-affiliated server.

12. The method of claim 11, wherein the user-input comprises user-selected or user-created data entered in the at least one of the plurality of user-input fields and wherein the form metadata comprises at least one of a publisher ID, a form ID, and a form field ID.

13. A system comprising:
a publisher,
the publisher containing:
means for receiving a script code from an ad-affiliated server;
means for generating on a client browser an electronic form embedded with the script code, the electronic form including a set of advertisers generated upon execution of the embedded script code, the embedded script code configured to monitor a plurality of user-input fields associated with the electronic form, wherein the monitoring includes detecting a change of user-input in at least one of the plurality of user-input fields and sending an advertiser request to the ad-affiliated server in response to a detected change;
means for receiving an updated set of advertisers returned from the ad-affiliated server, the updated set of advertisers being based on the user-input and in accordance with targeting parameters set by a network of advertisers connected to the ad-affiliated server; and
means for updating the set of advertisers;
means for generating a plurality of results in response to
a user submission of the electronic form; and
the ad-affiliated server,
the ad-affiliated server containing:
means for receiving the advertiser request;
means for determining the updated set of advertisers in response to the advertiser request; and
means for returning the updated set of advertisers to the publisher.

14. The system of claim 13, wherein the set of advertisers generated upon execution of the embedded script code comprises a null set of advertisers.

15. The system of claim 13, wherein the advertiser update request comprises real-time information associated with the electronic form, the real-time information containing the user-input and form metadata, wherein the real-time information is utilized by the ad-affiliated server to determine, from the network of advertisers, a subset of advertisers that corresponds to the targeting parameters.

16. The system of claim 13, wherein the means for generating a plurality of results comprises means for generating a plurality of advertising results associated with a subset of the set of advertisers.

17. A method comprising:
designating an advertising area on a webpage executed on a client browser; and
updating the advertising area with contextual advertisements returned from an ad-affiliated server connected to the client browser,
wherein return of the contextual advertisements from the ad-affiliated server is dynamically triggered based on user input on the webpage and in accordance with targeting parameters set by a network of advertisers connected to the ad-affiliated server.

18. The method of claim 17, wherein the advertising area is an iframe comprising iframe content provided by the ad-affiliated server, the iframe content including a search form and the contextual advertisements.

19. The method of claim 18, wherein the search form comprises a plurality of user-input fields, the plurality of user-input fields being monitored by the ad-affiliated server, wherein the monitoring includes detecting a change of the user-input in at least one of the plurality of user-input fields and sending a contextual advertisement request to the ad-affiliated server in response to a detected change.

20. The method of claim 19, wherein the contextual advertisement request comprises real-time information associated with the search form, the real-time information including form metadata and the user input,
the user input containing user-selected or user-created data entered in the at least one of the plurality of user-input fields,
the form metadata containing at least one of a publisher ID, a form ID, a form element ID,
wherein the real-time information is utilized by the ad-affiliated server to determine appropriate contextual advertisements that correspond to the targeting parameters set by the network of advertisers.

21. The method of claim 17, wherein the advertising area is a content strip comprising the contextual advertisements.

22. The method of claim 21, wherein the content strip is attached to an electronic form embedded with a script code provided by the ad-affiliated server, the electronic form being generated on the webpage, the embedded script code being configured to monitor a plurality of user-input fields associated with the electronic form, the monitoring including detecting a change of the user-input in at least one of the plurality of user-input fields and sending a contextual advertisement request to the ad-affiliated server in response to a detected change.

23. The method of claim 22, wherein the contextual advertisement request comprises real-time information associated with the electronic form, the real-time information including form metadata and the user input,
the user input containing user-selected or user-created data entered in the at least one of the plurality of user-input fields,
the form metadata containing at least one of a publisher ID, a form ID, a form element ID,
wherein the real-time information is utilized by the ad-affiliated server to determine appropriate contextual advertisements that correspond to the targeting parameters set by the network of advertisers.

24. The method of claim 22, further comprising generating a plurality of results in response to a user submission of the electronic form, the plurality of results including a plurality of advertising results associated with the contextual advertisements.
